(19) United States
(12) Patent Application Publication
(10) Pub. No.: US 2004/0258849 A1
(43) Pub. Date: Dec. 23, 2004

(54) System for hot-dip galvanizing metal components

(76) Inventor: Rodney Boyd, Clinton, LA (US)

Correspondence Address: Henry E. Naylor & Associates, P.O. Box 86060, Baton Rouge, LA, 70879-6060, US

(21) Appl. No.: 10/667,807

(22) Filed: Sep. 22, 2003

Related U.S. Application Data
(63) Continuation-in-part of application No. 29/185,102, filed on Jun. 23, 2003, now Pat. No. D492332.

(51) Int. Cl. B05C 3/00

(52) U.S. Cl. 427/433; 118/400

(57) ABSTRACT

A system for hot-dip galvanizing metal components. The system is comprised of: i) a lifting device; ii) a lifting bow; and iii) a tank containing a molten galvanizing composition.

### CROSS-REFERENCE TO RELATED APPLICATIONS

This is a continuation-in-part of U.S. Ser. No. 29/185,102 filed Jun. 23, 2003 and Attorney Docket No. 1.912.3 entitled Lifting Bow filed Aug. 18, 2003.

### BACKGROUND OF THE INVENTION

1. Field of the Invention

This invention relates to a system for hot-dip galvanizing metal components. The system is comprised of: i) a lifting device; ii) a lifting bow; and iii) a tank containing a molten galvanizing composition.

2. Description of Related Art

Hot-dip galvanizing is a well established process for protecting metal components, typically those of iron or steel, from corrosion by coating them with zinc. The metal component to be protected will typically first be pretreated using a series of pretreatment steps. Such steps usually include a caustic cleaning step wherein a hot alkali solution is used to remove contaminants, such as dirt, grease etc. The metal component is then rinsed and subjected to a pickling step wherein scale and rust are removed using a dilute acid solution, such as hot sulfuric acid or ambient temperature hydrochloric acid. The metal component is again rinsed then subjected to a fluxing step to remove oxides and to prevent additional oxidation from happening on the surface of the metal component prior to galvanizing. The metal components, after going through these pretreatment steps, are then dipped into the hot molten galvanizing composition for an effective amount of time to sufficiently galvanize the metal component.

While hot-dip galvanizing has been practiced for many years, there still remains a need for improved galvanizing systems that are more efficient and that provide a greater degree of safety for workers.

### SUMMARY OF THE INVENTION

In accordance with the present invention there is provided a system for hot-dip galvanizing metal components, the system comprising:

a) a lifting device detachably attached to a lifting bow by an attaching means;

b) a lifting bow detachably attached to said lifting device, said lifting bow being comprised of plate metal of at least about 0.5 inches thick, said lifting bow having a first face, a second face, a top section, a bottom section, and two side sections, wherein said bottom section is substantially broader than said top section, and wherein said top section contains a cutout for receiving said attaching means of said lifting device, and wherein said bottom section having a plurality of means for hanging metal components to be galvanized; and

c) a tank containing a molten metal galvanizing composition, said tank being of sufficient size to receive a sufficient amount of molten galvanizing composition to submerge at least a portion of the bottom section of said lifting bow into said molten metal galvanizing composition.

In a preferred embodiment the plurality of hanging means are cutouts along the bottom section of the lifting bow.

In another preferred embodiment of the present invention the hanging means are metal structures permanently attached to said bottom section of said lifting bow.

Also in accordance with the present invention there is provided a method for hot-dip galvanizing metal components using a system comprising: a) a lifting device detachably attached to a lifting bow by an attaching means;

b) a lifting bow detachably attached to said lifting device, said lifting bow being comprised of plate metal of at least about 0.5 inches thick, said lifting bow having a first face, a second face, a top section, a bottom section, and two side sections, wherein said bottom section is substantially broader than said top section, and wherein said top section contains a cutout for receiving said attaching means of said lifting device, and wherein said bottom section having a plurality of means for hanging metal components to be galvanized; and

c) a tank; said method comprising the steps of:

providing a molten metal galvanizing composition in said tank for galvanizing metal components;

attaching at least one metal component to a hanging means of said lifting bow, which lifting bow is detachably attached to a lifting device;

lowing the lifting bow by use of the lifting device toward the molten metal galvanizing composition so that said at least one metal component to be galvanized is at least partially submerged in said molten metal galvanizing composition for an effective amount of time; and

raising said lifting bow with said lifting device after said effective amount of time so that said metal components are no longer in contact with said molten metal galvanizing composition.

In a preferred embodiment the molten metal galvanizing composition is a molten zinc composition.

### BRIEF DESCRIPTION OF THE FIGURES

FIGS. 1a and 1b are two different views of a preferred lifting bow of the present invention showing metal structures being permanently attached to the bottom section for hanging metal components to be galvanized.

FIGS. 2a and 2b are two different views of another preferred lifting bow of the present invention showing cutouts along the bottom section for either hanging metal components to be galvanized or for hanging a detachable hanging device suitable for hanging metal components to be galvanized.

FIG. 3 is a schematic of the hot-dip galvanizing system of the present invention showing the lifting bow detachably attached to a lifting device and showing a plurality of metal components to be galvanized before being submerged in the molten metal galvanizing composition.

FIG. 4 is a schematic of the hot-dip galvanizing system of the present invention showing the lifting bow detachably attached to a lifting device and showing a plurality of metal components submerged in the molten metal galvanizing composition.

### DETAILED DESCRIPTION OF THE INVENTION

The present invention relates to a system for hot-dip galvanizing metal components. Galvanizing is an essential metal finishing process that provides long term corrosion protection on metals, such as iron and steel. In order for the metal to be properly galvanized, a rust or oxide-free metal surface must be available for the molten zinc to correctly metallurgically alloy with the steel component being galvanized. Galvanizing forms a metallurgical bond between the zinc coating and the underlying steel or iron creating a barrier that is a part of or an extension of the metal component itself. During galvanizing, the molten zinc reacts with the surface of the iron or steel component undergoing galvanizing to form a series of zinc/iron alloys. A typical galvanized coating is comprised of three alloy layers and a layer of metallic zinc. Moving from the most underlying metal surface outward, these are: the thin gamma layer comprised of an alloy that is about 75 wt. % zinc and about 25 wt. % iron; the delta layer that is comprised of an alloy that is about 90 wt. % zinc and about 10 wt. % iron, and the zeta layer that is comprised of an alloy that is about 94 wt. % zinc and about 6 wt. % iron. The outer, or eta layer is comprised substantially of zinc. Although zinc is by far the most common galvanizing metal in use today, the galvanizing system of the present invention can be used to dip metal components into any molten metal composition.

As previously mentioned, the metal component to be galvanized must first be pretreated in order to ensure proper galvanization. The metal component will typically first be subjected to a caustic cleaning step to remove organic contaminants, such as dirt, paint markings, grease, and oil. If the metal component to be galvanized contains epoxies, vinyls, asphalts, or welding slag they are preferably removed by grit or sand blasting, or by any other suitable mechanical means. The caustic will preferably be an aqueous alkaline solution, more preferably a sodium hydroxide solution that can be used either at room temperature or at elevated temperatures up to about 100° C. or greater. It will be understood that each pretreatment step, as well as the rinse and final galvanizing steps, will take place in suitable tanks. That is, each pretreatment solution, rinse, and galvanizing composition will be contained in a tank of suitable composition, structure, and size to allow the metal components to be submerged therein and that is capable of withstanding the treatment media and conditions under which the treatment media is kept and used.

The metal component, after caustic cleaning, will be rinsed, preferably with water, then passed on to a pickling step wherein it is submerged in a dilute acid solution, preferably a hydrochloric acid solution, to remove surface rust and mill scale and to provide a chemically clean metal surface. The metal component, after pickling, is again rinsed then passed to a fluxing step wherein the metal component is submerged in a flux effective to remove oxides and to prevent oxidation prior to dipping the metal component into the molten zinc composition. The flux will typically be a zinc salt solution, such as zinc ammonium chloride solution. In a dry galvanizing process, the metal component would be separately dipped in a liquid flux bath, removed and allowed to dry prior to galvanizing. In a wet galvanizing process, the flux floats on top of the molten zinc and the metal component passes through the flux immediately prior to galvanizing when it is submerged in the tank of galvanizing composition.

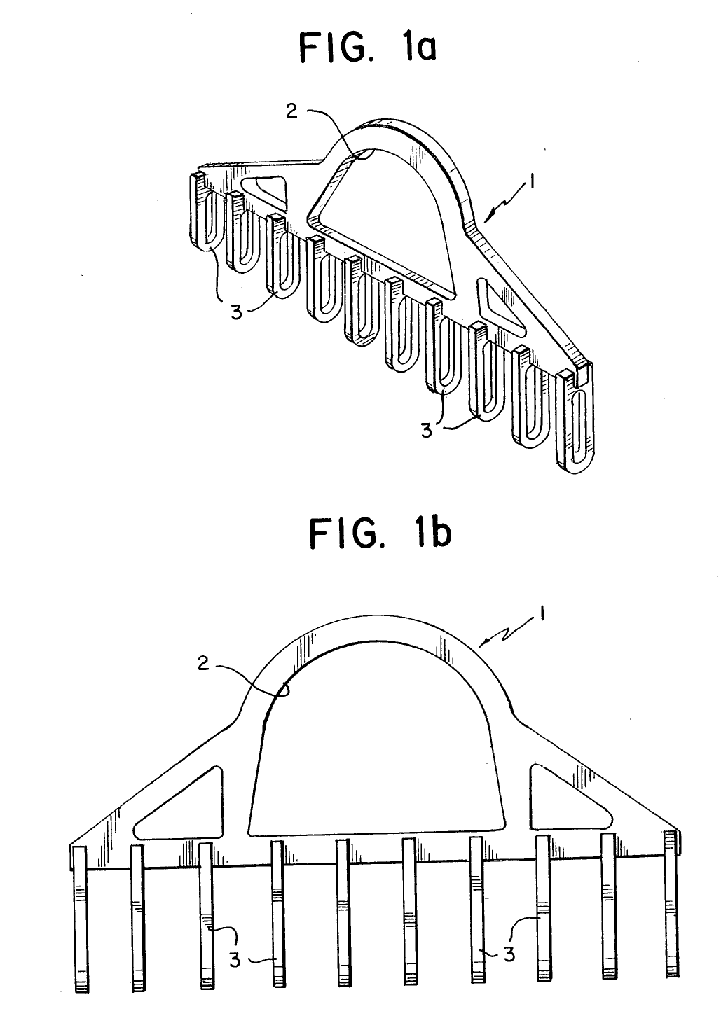

Turning now to FIG. 1a there is provided a preferred lifting bow 1 of the present invention. Lifting bow 1 is comprised of plate metal, preferably carbon steel, having a thickness t from about 0.25 to about 1.25 inches, preferably from about 0.5 to 0.75 inches, and more preferably about 0.5 inches, depending on the size and weight of the metal components to be hung therefrom to be galvanized. The top section of lifting bow 1 contains a cutout 2 for receiving a detachable attaching means (not shown) from a lifting device (not shown). The bottom section of lifting bow 1 contains a plurality of hanging means 3 for hanging metal components to be galvanized. FIG. 1b is another perspective of lifting bow 1. Hanging means 3 are metal structures, in the form of ovals, that are welded onto the bottom section of lifting bow 1. These metal structures will be of suitable composition, preferably carbon steel, and of sufficient dimension for their intended purpose.

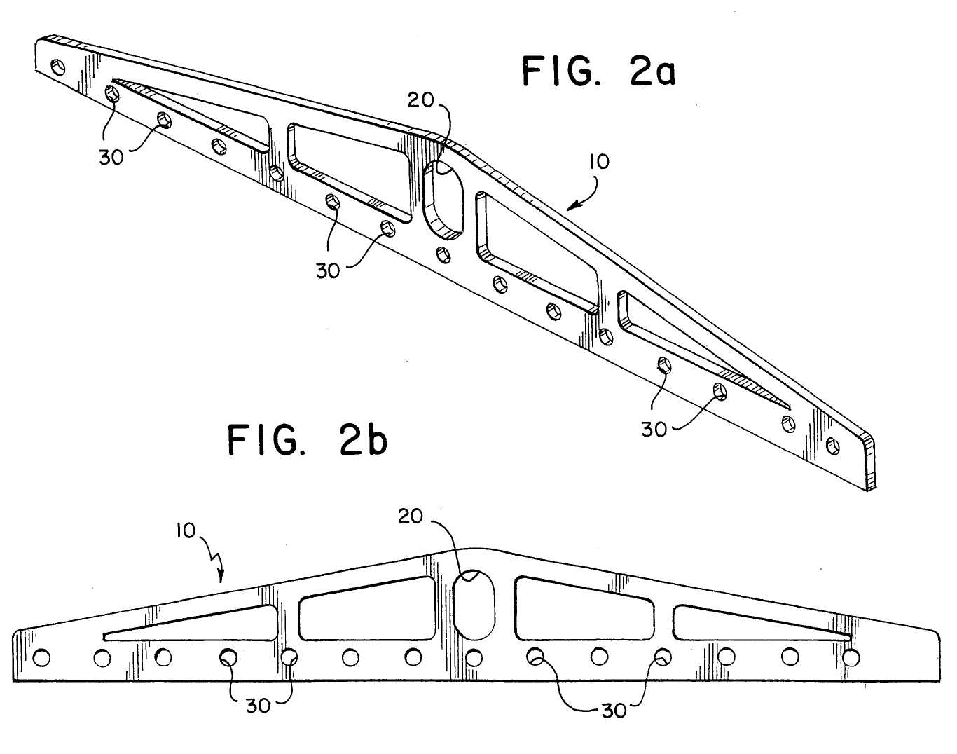

FIGS. 2a and 2b hereof represent another preferred lifting bow of the present invention. Lifting bow 10 contains cutout 20 at its top section for receiving a detachable attaching means (not shown) from a lifting device (not shown) for transporting the lifting bow from step to step in the pretreatment and galvanizing process. Lifting bow 20 also contains a plurality of hanging means 3 represented by a series of cutouts, preferably circular, at the bottom section of the lifting bow. These cutouts can either receive the metal components directly or they can receive a hook, such as an S-hook on which the metal component to be galvanized are hung.

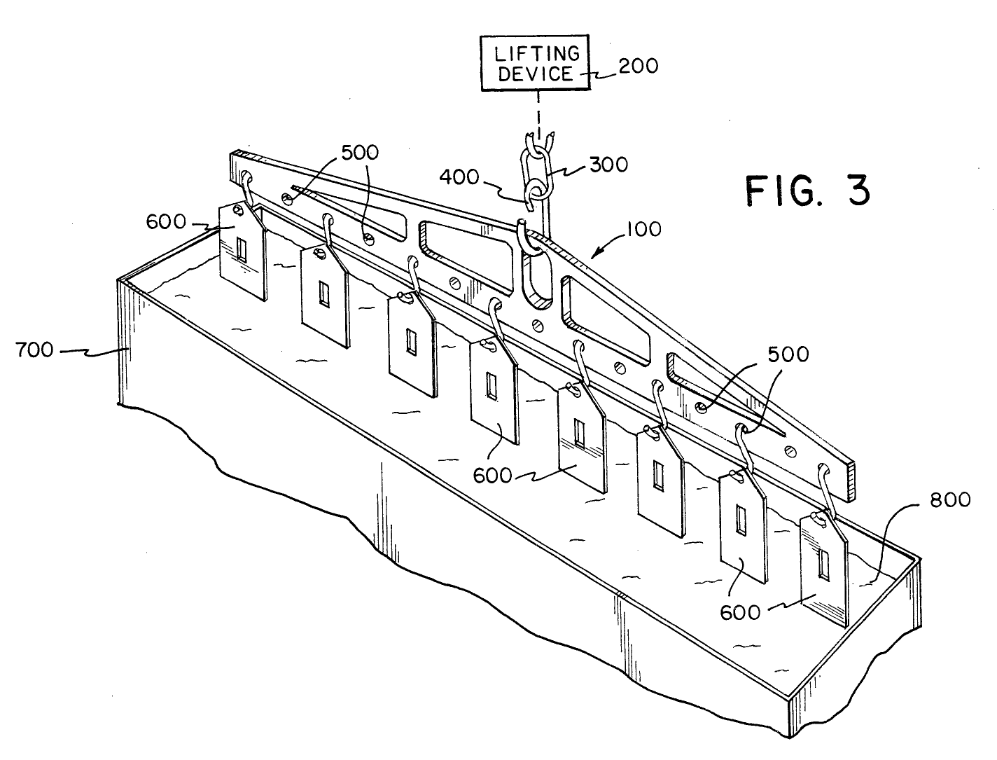

FIG. 3 hereof is a schematic of the hot-dip galvanizing system of the present invention prior to submersion of the metal component into a tank of pretreatment composition or molten metal galvanizing composition. FIG. 3 shows a lifting device 200 having a detachable attaching means 300 for attaching at the top section of lifting bow 100. The attaching means can be any suitable structure for attaching to the lifting bow that are able to provide the strength and high temperature use demanded in the industry. Preferred attaching means include steel cables and chains. The end of the attaching means 300 can contain a suitable hooking means such as a hook or a clamp 400 that can be permanently open or opened and closed to hold the lifting bow. Lifting bow 300 contains a plurality of hanging means 500 of suitable composition and shape to receive and hang metal components 600 to be galvanized. In this figure, the hanging means is represented by a plurality of circular cutouts, but they can also be as presented in FIGS. 1a and 1b hereof in for form of oval structures attached to the bottom section of the lifting bow. There is also provided a tank 700 containing a liquid composition 800 into which the metal components can be lowered by use of lifting device 200 and submerged into the liquid composition for an effective amount of time.

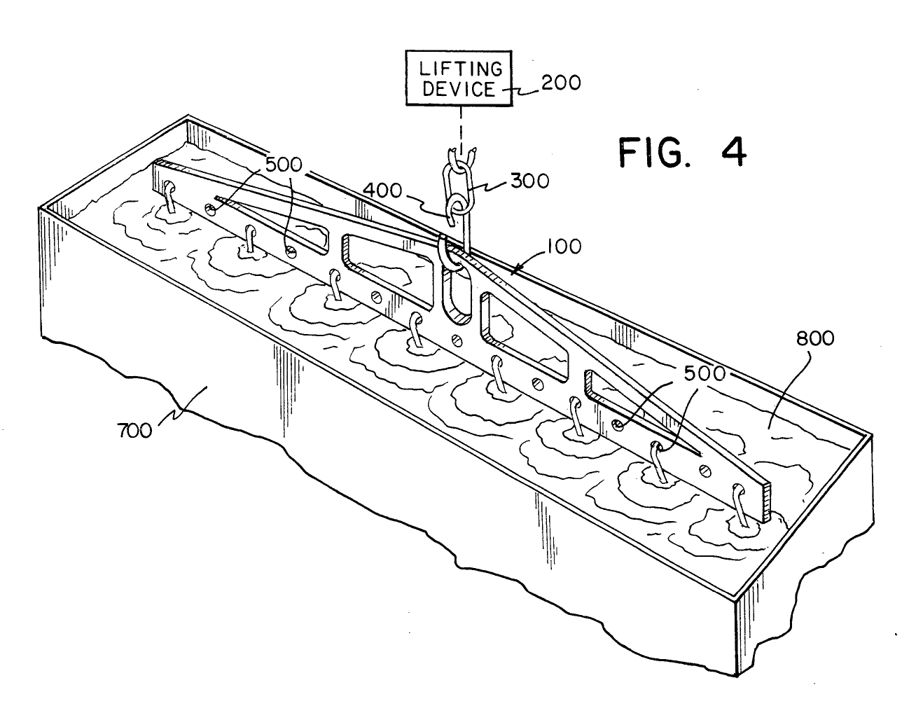

FIG. 4 hereof shows the hot-dip galvanizing system of the present invention in the position wherein the metal components are submerged in the liquid composition 800 contained in tank 700. It will be understood that the lifting device can be any piece of equipment normally used to lift heavy objects. It is preferred that the lifting means be powered by a suitable power source including electric and equipment run by combustion fuels. Such powered lifting equipment includes, but is not limited to, cranes, forklifts, derricks, etc. The lifting device can also be a simple non-powered block-and-tackle that is operated by an operator to lift the lifting bow in and out of the treatment media in the tanks.

The present invention is practiced by attaching the lifting bow to the lifting device by a the detachable attaching means 300/400 and loading, or hanging, metal components 600 onto the plurality of hanging means 500 of said lifting bow. The lifting device is operated to transport the lifting bow containing the metal components to be galvanized to the appropriate tank. In the case where the metal components are to be pretreated the first tank is one containing an aqueous caustic solution wherein the metal components are submerged for an effective amount of time to remove substantially all of the organic contaminants from the surfaces of the metal component. The lifting bow is then raised with use of the lifting device and transported with the metal components to a rinse tank, preferably containing water, and submerged to rinse off any remaining caustic solution. The lifting bow is then raised and transported with the metal components hanging therefrom to a picking tank containing a pickling composition, preferably a dilute acid, more preferably a hydrochloric acid solution and kept there for an effective amount of time to remove any scale or rust from the surface of the metal components. The lifting bow with the treated metal components is then moved and lowered into another rinse tank containing a rinse solution, preferably water, then transported to and submerged into a tank containing a suitable flux material that is capable of removing oxides from the surface of the metal components and to prevent further oxidation of the metal component surface prior to galvanizing. The lifting bow with the so-treated metal components is then transported to and submerged into a molten metal galvanizing composition at an effective temperature and for an effective amount of time to cause the metal component to become sufficiently galvanized. The temperature of the molten metal galvanizing composition, which will most preferably be a molten zinc composition, will be from about 830° F. to abut 875° F., preferably from about 850° C. to about 870° C.

What is claimed is:

1. A system for hot-dip galvanizing metal components, the system comprising:
a) a lifting device detachably attached to a lifting bow by an attaching means;
b) a lifting bow detachably attached to said lifting device, said lifting bow being comprised of plate metal of at least about 0.25 inches thick, said lifting bow having a first face, a second face, a top section, a bottom section, and two side sections, wherein said bottom section is substantially broader than said top section, and wherein said top section contains a cutout for receiving said attaching means of said lifting device, and wherein said bottom section having a plurality of means for hanging metal components to be galvanized; and
c) a tank containing a molten metal galvanizing composition, said tank being of sufficient size to receive a sufficient amount of molten galvanizing composition to submerge at least a portion of the bottom section of said lifting bow into said molten metal galvanizing composition.

2. The hot-dip galvanizing system of claim 1 wherein the plurality of hanging means are cutouts along the bottom section of the lifting bow.

3. The hot-dip galvanizing system of claim 1 wherein the present invention the hanging means are metal structures permanently attached to said bottom section of said lifting bow.

4. A method for hot-dip galvanizing metal components with a system comprising: a) a lifting device detachably attached to a lifting bow by an attaching means;
b) a lifting bow detachably attached to said lifting device, said lifting bow being comprised of plate metal of at least about 0.5 inches thick, said lifting bow having a first face, a second face, a top section, a bottom section, and two side sections, wherein said bottom section is substantially broader than said top section, and wherein said top section contains a cutout for receiving said attaching means of said lifting device, and wherein said bottom section having a plurality of means for hanging metal components to be galvanized; and
c) a tank; said method comprising the steps of:
providing a molten metal galvanizing composition is said tank for galvanizing metal components;
attaching at least one metal component to a hanging means of said lifting bow, which lifting bow is detachably attached to a lifting device;
lowing the lifting bow with the lifting device toward the molten metal galvanizing composition so that said at least one metal component to be galvanized is submerged in said molten metal galvanizing composition for an effective amount of tme; and;
raising said lifting bow with said lifting device so that said at least one metal component is no longer in contact with said molten metal galvanizing composition.

5. The method of claim 4 wherein the molten metal galvanizing composition is a molten zinc composition.

6. The method of claim 5 wherein said lifting device is a crane.
